(19) United States
(12) Patent Application Publication
(10) Pub. No.: US 2007/0258360 A1
(43) Pub. Date: Nov. 8, 2007

(54) Radio Base Station Device, Radio Control System, and Operation Control Method

(76) Inventors: Satoshi Senga, Tokyo (JP); Hidenori Ishii, Tokyo (JP); Kenji Takagi, Kanagawa (JP)

Correspondence Address: WENDEROTH, LIND & PONACK L.L.P., 2033 K. STREET, NW, SUITE 800, WASHINGTON, DC, 20006, US

(21) Appl. No.: 11/629,288

(22) PCT Filed: Mar. 18, 2005
(86) PCT No.: PCT/JP05/04943

§ 371 Date: Dec. 13, 2006

(30) Foreign Application Priority Data
Jun. 29, 2004 (JP) 2004-191024

(51) Int. Cl. H04J 3/14; H04Q 7/00

(52) U.S. Cl. 370/218; 370/329

(57) ABSTRACT

A radio base station device (3) comprises: a call processing control unit for transferring a signaling control signal, and transmitting a failure detection packet to a plurality of transmission paths (5) connected to a radio network controller so as to detect failure of each of the transmission paths (5); a baseband signal processing unit for transferring a user data control signal; a channel management table storing a currently set up channel and a transmission path used by the channel, as being associated with each other; and a channel management control unit for, in response to detection of failure of a transmission path (5) by the call processing control unit, receiving information indicating a state of each of the transmission paths from the call processing control unit, changing a currently set up channel to a transmission path (5) having no failure detected, and notifying the call processing control unit and the baseband signal processing unit of an address related to the transmission path (5) to which the currently set up channel is changed. Consequently, upon failure of an IP transmission path, the IP transmission path can be changed without interruption of voice and disconnection of a call at the time of failure.

### TECHNICAL FIELD

The present invention relates to a radio base station device supporting an IP transmission system, and to an operation control method of the device. In particular, the present invention relates to a control method for IP transmission paths between a radio base station device and a radio network controller in an IP-based radio access network.

### BACKGROUND ART

FIG. 9 shows the architecture of a W-CDMA (Wideband Code Division Multiple Access) communications system, which is a mobile communications system. A radio access network (RAN) 100 comprises a radio network controller (RNC) 200 and a radio base station device 300. The RAN is connected to a core network (CN) 400, which is an exchange network, via an Iu interface. The base station 300 is a logical node that performs radio transmission and reception, and is also called a Node B. An interface between the base station 300 and the RNC 200 is called an Iub. Each base station 300 is connected with user equipment (UE) 500 via a radio interface. The base station 300 terminates a radio link, and the RNC 200 performs management of the base station 300 and selection combining of radio paths for soft handover. Details of the architecture shown in FIG. 9 is defined in 3GPP (3rd Generation Partnership Project) Release 99.

FIG. 10 shows a block diagram illustrating a configuration of the base station 300. The base station 300 is connected via a wired transmission path unit 110 to an RNC wired transmission path unit 140 of the RNC 200. In order to handle failure of a transmission path, the base station 300 has a reserve wired transmission path unit 120, and the RNC 200 has an RNC reserve wired transmission path unit 130. When a failure occurs in a transmission path, the base station 300 changes the wired transmission path unit 110 to the reserve wired transmission path unit 120, and the RNC 200 changes the RNC wired transmission path unit 140 to the RNC reserve wired transmission path unit 130. The base station 300 comprises: a call processing control unit 1000 for processing a signaling control signal; a baseband signal processing unit 600 for processing user data; a maintenance and monitoring control unit 900 for processing a maintenance and monitoring control signal; a radio unit 800 for converting a signal subjected to a diffusion process by the baseband signal processing unit 600 into a transmission radio frequency signal; and a transmission and reception amplification unit 700 for amplifying power of a transmission radio frequency signal to a specified level.

The 3GPP is promoting standardization for applying IP technology to RAN, and has defined specifications for using IP instead of ATM, which is defined in 3GPP release 99, for Iub transmission, the specifications being TS 25.426 “UTRAN Iur and Iub interface data transport & transport signalling for DCH data streams” (http://www.3gpp.org/ftp/Specs/html-info/25426.htm), and TS 25.432 “UTRAN Iub interface: signalling transport” (http://www.3gpp.org/ftp/Specs/html-info/25432.htm). It is defined that, on the Iub, C-(Control) plane for signaling for transfer control of a control signal by the call processing control unit 1000 is to be transmitted in accordance with a transport layer protocol SCTP (Stream Control Transmission Protocol) defined in IETF (The Internet Engineering Task Force) RFC 2960, and that U-(User) plane for transfer control of user data by the baseband signal processing unit 600 is to be transmitted in accordance with UDP (User Datagram Protocol) defined in IETF RFC 768.

### DISCLOSURE OF THE INVENTION

Problems to be Solved By the Invention

Conventional ATM defined in 3GPP Release 99 is highly reliable, so that an RNC and a base station have been connected to each other by a single transmission path. Also in the above-mentioned specifications, the base station 300 and the RNC 200 are connected to each other by a single IP transmission path on the Iub of the radio access network (RAN) 100. SCTP is used as a transport layer protocol for C-plane and UDP is used as a transport layer protocol for U-plane, so that data is transmitted over each transmission path.

Since IP transmission paths are less reliable than ATM, failure of a transmission path may occur, caused by congestion or the like. In the above-mentioned specifications, however, detection of failure of an IP transmission path is not defined for C-plane transmission and U-plane transmission.

As described in FIG. 10, there is also a method in which a reserve transmission path is provided for handling failure. However, providing a reserve IP transmission path alone requires stopping transmission of C-plane and U-plane for a moment, when a failure occurs and prevents IP transmission from continuing. The IP transmission path is then changed to the reserve IP transmission path and a session is established again so that IP transmission is restarted. That is, congestion or failure of an IP transmission path is handled as follows: time required for a transmitted packet to arrive is judged separately for each plane; and a session is established again for each plane for changing to another transmission path, only if it is judged that there has been no arrival for a certain period of time. Such method requires much time for restarting IP transmission. This leads to an interruption of voice when a failure occurs, and even leads to a disconnection of a call.

A purpose of the invention made in the above-mentioned background is to provide a radio base station device, radio control system, and operation control method that, upon a state of congestion caused by an increase in communication data and upon an unexpected failure of an IP transmission path, change the IP transmission path to a reserve IP transmission path without interruption of voice and disconnection of a call at the time of failure.

Means for Solving the Problems

A radio base station device of the invention comprises: a call processing control unit for transferring a signaling control signal, and transmitting a failure detection packet to a plurality of transmission paths connected to a radio network controller so as to detect failure of each of the transmission paths; a baseband signal processing unit for transferring a user data control signal; a channel management table storing a currently set up channel and a transmission path used by the channel, as being associated with each other; and a channel management control unit for, in response to detection of failure of a transmission path by the call processing control unit, receiving information indicating a state of each of the transmission paths from the call processing control unit, identifying with reference to the channel management table a channel using the transmission path having failure detected, changing the identified channel to a transmission path having no failure detected, and notifying the call processing control unit and the baseband signal processing unit of an address related to the transmission path to which the identified channel is changed. In the above-mentioned radio base station device, the channel management control unit may update the channel management table in response to a setup and release of a channel with a radio network controller. Also in the above-mentioned radio base station device, the channel management control unit may determine the transmission path to which the identified channel is to be changed, based on travel time information of the failure detection packet included in information indicating a state of each of the transmission paths. Furthermore, the above-mentioned radio base station device may comprise a priority-of-use storage unit storing information indicating a predetermined priority of use for each of the transmission paths, and the channel management control unit may determine the transmission path to which the identified channel is to be changed, based on the priority of use for each transmission path read from the priority-of-use storage unit.

A radio network controller of the invention comprises: a call processing control unit for transferring a signaling control signal, and transmitting a failure detection packet to a plurality of transmission paths connected to a radio base station device so as to detect failure of each of the transmission paths; a baseband signal processing unit for transferring a user data control signal; a channel management table storing a currently set up channel and a transmission path used by the channel, as being associated with each other; and a channel management control unit for, in response to detection of failure of a transmission path by the call processing control unit, receiving information indicating a state of each of the transmission paths from the call processing control unit, identifying with reference to the channel management table a channel using the transmission path having failure detected, changing the identified channel to a transmission path having no failure detected, and notifying the call processing control unit and the baseband signal processing unit of an address related to the transmission path to which the identified channel is changed.

A radio control system of the invention is for performing communication between a portable terminal and a radio network controller via a radio base station device, the radio base station device and the radio network controller being connected to each other by a plurality of transmission paths, the radio base station device and the radio network controller comprising: a call processing control unit for transferring a signaling control signal, and transmitting a failure detection packet to each of the transmission paths so as to detect failure of each of the transmission paths; a baseband signal processing unit for transferring a user data control signal; a channel management table storing a currently set up channel and a transmission path used by the channel, as being associated with each other; and a channel management control unit for, in response to detection of failure of a transmission path by the call processing control unit, receiving information indicating a state of each of the transmission paths from the call processing control unit, identifying with reference to the channel management table a channel using the transmission path having failure detected, changing the identified channel to a transmission path having no failure detected, and notifying the call processing control unit and the baseband signal processing unit of an address related to the transmission path to which the identified channel is changed.

An operation control method of the invention is of a radio base station device, the radio base station device comprising: a call processing control unit for transferring a signaling control signal; a baseband signal processing unit for transferring a user data control signal; and a channel management control unit for managing a channel set up with the radio network controller, the operation control method comprising: a table update step in which the channel management control unit, in response to a setup and release of the channel, updates a channel management table storing a currently set up channel and a transmission path used by the channel, as being associated with each other; a failure detection step in which the call processing control unit transmits a failure detection packet to a plurality of transmission paths connected to a radio network controller so as to detect failure of each of the transmission paths; a state-of-transmission-path transmission step in which the call processing control unit, in response to detection of failure of a transmission path in the failure detection step, transmits information indicating a state of each of the transmission paths to the channel management control unit; and a transmission path change step in which the channel management control unit identifies with reference to the channel management table a channel using the transmission path having failure detected, changes the identified channel to a transmission path having no failure detected, and notifies the call processing control unit and the baseband signal processing unit of an address related to the transmission path to which the identified channel is changed.

There are other aspects of the invention as described below. This disclosure of the invention therefore intends to provide part of aspects of the invention and does not intend to limit the scope of the invention claimed herein.

### BRIEF DESCRIPTION OF THE DRAWINGS

FIG. 1 shows an architecture of a W-CDMA communications system according to a first embodiment;

FIG. 2 shows a configuration of a radio base station device according to the first embodiment;

FIG. 3 is an operation sequence diagram showing an internal process flow of transmission channel management according to the first embodiment;

FIG. 4 is an operation sequence diagram showing an internal process flow of a transmission path change according to the first embodiment;

FIG. 5 shows a channel management table according to the first embodiment;

FIG. 6 shows failure detection information according to the first embodiment;

FIG. 7 shows a stop request according to the first embodiment;

FIG. 8 shows a change control request according to the first embodiment;

FIG. 9 shows an architecture of a conventional W-CDMA communications system; and

FIG. 10 shows a configuration of a conventional radio base station device.

### BEST MODE OF EMBODYING THE INVENTION

Now, the invention will be described in detail. However, the following detailed description and appended drawings are not intended to limit the invention. The scope of the invention is defined by the appended claims.

A radio base station device of the embodiment comprises: a call processing control unit for transferring a signaling control signal, and transmitting a failure detection packet to a plurality of transmission paths connected to a radio network controller so as to detect failure of each of the transmission paths; a baseband signal processing unit for transferring a user data control signal; a channel management table storing a currently set up channel and a transmission path used by the channel, as being associated with each other; and a channel management control unit for, in response to detection of failure of a transmission path by the call processing control unit, receiving information indicating a state of each of the transmission paths from the call processing control unit, identifying with reference to the channel management table a channel using the transmission path having failure detected, changing the identified channel to a transmission path having no failure detected, and notifying the call processing control unit and the baseband signal processing unit of an address related to the transmission path to which the identified channel is changed.

As above, the radio base station device and the radio network controller are connected to each other by a plurality of transmission paths, and the radio base station device transmits a failure detection packet to the plurality of transmission paths so as to detect failure of each of the transmission paths. When occurrence of a failure is detected in a transmission path in which a channel is set up, the channel management control unit changes the channel set up in the transmission path where the failure has occurred to a transmission path where no failure has occurred, and then a signaling control signal and a user data control signal are transmitted. This can reduce the possibility of an interruption of voice and disconnection of a call at the time of failure.

In the radio base station device, the channel management control unit may update the channel management table in response to a setup and release of a channel with a radio network controller.

A state of channel setup can be grasped by updating the channel management table as above in response to a setup and release of a channel.

In the radio base station device, the channel management control unit may determine the transmission path to which the identified channel is to be changed, based on travel time information of the failure detection packet included in information indicating a state of each of the transmission paths.

By determining the transmission path to which the identified channel is to be changed, based on travel time information of the failure detection packet as above, a transmission path can be changed to a transmission path being in a good transmission state.

The radio base station device may comprise a priority-of-use storage unit storing information indicating a predetermined priority of use for each of the transmission paths, and the channel management control unit may determine the transmission path to which the identified channel is to be changed, based on the priority of use for each transmission path read from the priority-of-use storage unit.

This allows the priority of use for the transmission paths to be set in advance according to characteristics of the transmission paths or the like.

A radio network controller of the embodiment comprises: a call processing control unit for transferring a signaling control signal, and transmitting a failure detection packet to a plurality of transmission paths connected to a radio base station device so as to detect failure of each of the transmission paths; a baseband signal processing unit for transferring a user data control signal; a channel management table storing a currently set up channel and a transmission path used by the channel, as being associated with each other; and a channel management control unit for, in response to detection of failure of a transmission path by the call processing control unit, receiving information indicating a state of each of the transmission paths from the call processing control unit, identifying with reference to the channel management table a channel using the transmission path having failure detected, changing the identified channel to a transmission path having no failure detected, and notifying the call processing control unit and the baseband signal processing unit of an address related to the transmission path to which the identified channel is changed.

Consequently, as in the case of the above-mentioned radio base station device, the possibility of an interruption of voice and disconnection of a call at the time of failure can be reduced also when a failure occurs in a transmission path. Each configuration of the above-mentioned radio base station device can be applied to this radio network controller.

A radio control system of the embodiment is for performing communication between a portable terminal and a radio network controller via a radio base station device, the radio base station device and the radio network controller being connected to each other by a plurality of transmission paths, the radio base station device and the radio network controller comprising: a call processing control unit for transferring a signaling control signal, and transmitting a failure detection packet to each of the transmission paths so as to detect failure of each of the transmission paths; a baseband signal processing unit for transferring a user data control signal; a channel management table storing a currently set up channel and a transmission path used by the channel, as being associated with each other; and a channel management control unit for, in response to detection of failure of a transmission path by the call processing control unit, receiving information indicating a state of each of the transmission paths from the call processing control unit, identifying with reference to the channel management table a channel using the transmission path having failure detected, changing the identified channel to a transmission path having no failure detected, and notifying the call processing control unit and the baseband signal processing unit of an address related to the transmission path to which the identified channel is changed.

Consequently, as in the case of the above-mentioned radio base station device, the possibility of an interruption of voice and disconnection of a call at the time of failure can be reduced also when a failure occurs in a transmission path. Each configuration of the above-mentioned radio base station device can be applied to this radio control system.

An operation control method of the embodiment is of a radio base station device, the radio base station device comprising: a call processing control unit for transferring a signaling control signal; a baseband signal processing unit for transferring a user data control signal; and a channel management control unit for managing a channel set up with the radio network controller, the operation control method comprising: a table update step in which the channel management control unit, in response to a setup and release of the channel, updates a channel management table storing a currently set up channel and a transmission path used by the channel, as being associated with each other; a failure detection step in which the call processing control unit transmits a failure detection packet to a plurality of transmission paths connected to a radio network controller so as to detect failure of each of the transmission paths; a state-of-transmission-path transmission step in which the call processing control unit, in response to detection of failure of a transmission path in the failure detection step, transmits information indicating a state of each of the transmission paths to the channel management control unit; and a transmission path change step in which the channel management control unit identifies with reference to the channel management table a channel using the transmission path having failure detected, changes the identified channel to a transmission path having no failure detected, and notifies the call processing control unit and the baseband signal processing unit of an address related to the transmission path to which the identified channel is changed.

Consequently, as in the case of the above-mentioned radio base station device, the possibility of an interruption of voice and disconnection of a call at the time of failure can be reduced also when a failure occurs in a transmission path. Each configuration of the above-mentioned radio base station device can be applied to this operation control method.

Now, the radio base station device and radio control system of the embodiment of the invention will be described with reference to the drawings. e

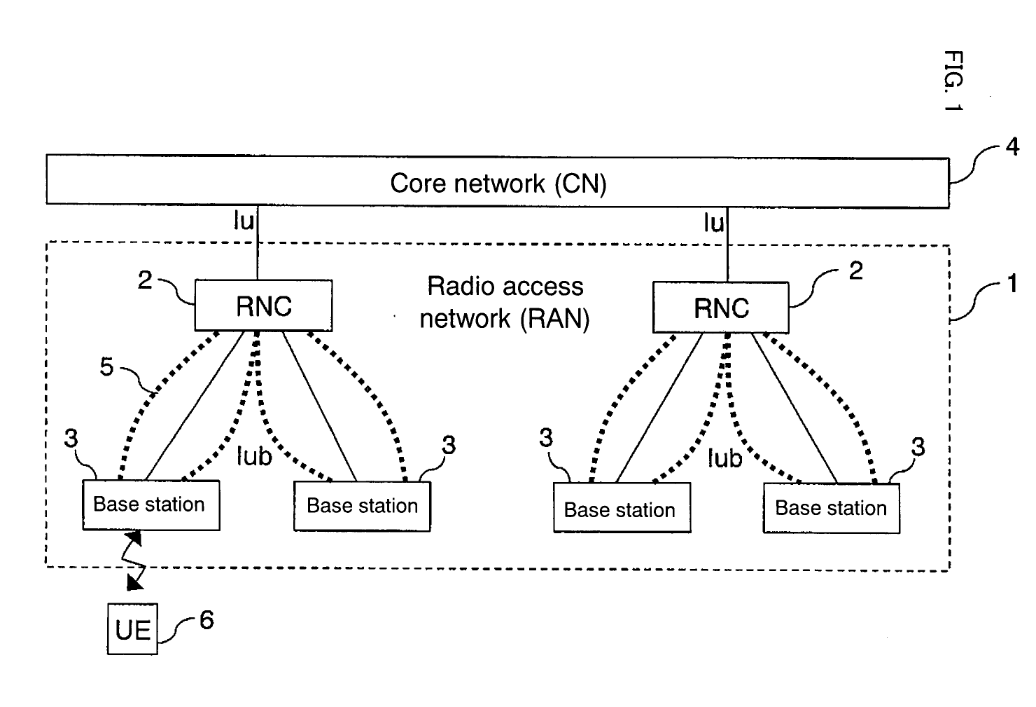

FIG. 1 is a schematic diagram illustrating a configuration of an architecture of a W-CDMA communications system which is applied to the embodiment of the invention. A radio access network (RAN) 1 comprises a radio network controller (RNC) 2 and a base station 3. The RAN 1 is connected to a core network (CN) 4, which is an exchange network, via an Iu interface. The base station 3 is a logical node that performs radio transmission and reception. An interface between the base station 3 and the RNC 2 is called an Iub. The base station 3 and the RNC 2 are connected to each other via a plurality of Iub interfaces 5. Each base station 3 and user equipment (UE) 6 are connected to each other via a radio interface. The base station 3 terminates a radio link, and the RNC 2 performs management of the base station 3 and selection combining of radio paths for soft handover.

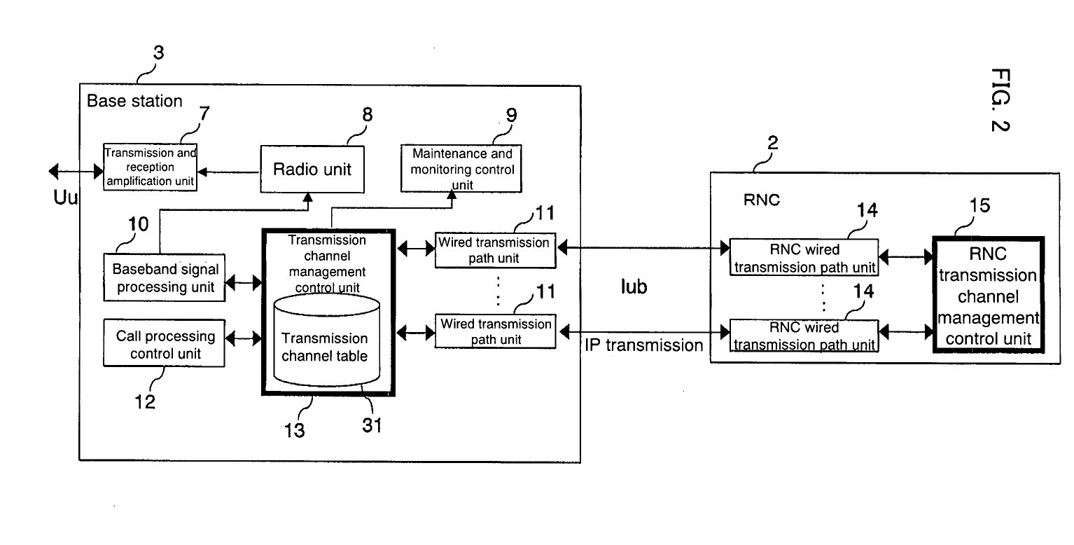

FIG. 2 shows a detailed configuration of the base station 3 which is applied to the embodiment of the invention. As shown in FIG. 2, the base station 3 has a plurality of wired transmission path units 11, and is connected to the RNC 2 via Iub interfaces. The wired transmission path unit 11 of the base station 3 is not required to correspond one-to-one with an RNC wired transmission path unit 14 of the RNC 2. For example, the base station 3 may have three wired transmission path units 11, and the RNC 2 may have one wired transmission path unit 14. In this case, the RNC 2 and the base station 3 are connected to each other via a hub or router device in an IP communications network used in the RAN 1. The base station 3 comprises: a call processing control unit 12 for performing transmission over the plurality of wired transmission path units 11 and transfer control of signaling; a baseband signal processing unit 10 for transfer control of user data; a transmission channel management control unit 13 for performing synchronization control of the call processing control unit 12 and the baseband signal processing unit 10 and transmission path change management; a maintenance and monitoring control unit 9 for processing a maintenance and monitoring control signal; a radio unit 8 for converting a signal subjected to a diffusion process by the baseband signal processing unit 10 into a transmission radio frequency signal; and a transmission and reception amplification unit 7 for amplifying power of a transmission radio frequency signal to a specified level. The call processing control unit 12 corresponds to a processing function unit for C-plane, and the baseband signal processing unit 10 corresponds to a processing function unit for U-plane.

An RNC transmission channel management control unit 15 and the RNC wired transmission path unit 14 placed in the RNC 2 have the same functions as the transmission channel management control unit 13 and the wired transmission path unit 11 of the base station 3, respectively. The RNC 2 is shown with other components thereof omitted.

SCTP used for transmission of C-plane is a protocol that supports multihoming, by which a plurality of transmission paths can be managed with one transport layer session. SCTP has a function to monitor all transmission paths (transfer paths). That is, the call processing control unit 12 periodically transmits a failure detection packet called a HEARTBEAT chunk to all transfer paths regardless of whether the path is used for data transfer or not, so as to monitor the state of the transmission paths.

With the state monitoring, failure of a transmission path can be detected. SCTP is defined in detail in IETF RFC 2960. In this configuration, the state of all transfer paths of the wired transmission path units 11 is constantly monitored by means of SCTP used for transmission of C-plane.

As a result of monitoring as above, when a failure is detected by SCTP in a transfer path used for transmission of C-plane and U-plane, the transmission channel management control unit 13 can immediately notify the call processing control unit 12 and the baseband signal processing unit 10 to change the transmission of C-plane and U-plane to an available transfer path. The call processing control unit 12 and the baseband signal processing unit 10 control the change of the transmission path, so that the base station 3 and the RNC 2 can change the path to an available transfer path at the same time.

Consequently in the device configuration like the one shown in FIG. 2, upon a state of congestion caused by an increase in communication data and upon an unexpected failure of an IP transmission path, the transmission channel management control unit 13 can perform a control to choose an available transmission path from the plurality of wired transmission path units 11 and to change the transfer path for C-plane and U-plane at the same time.

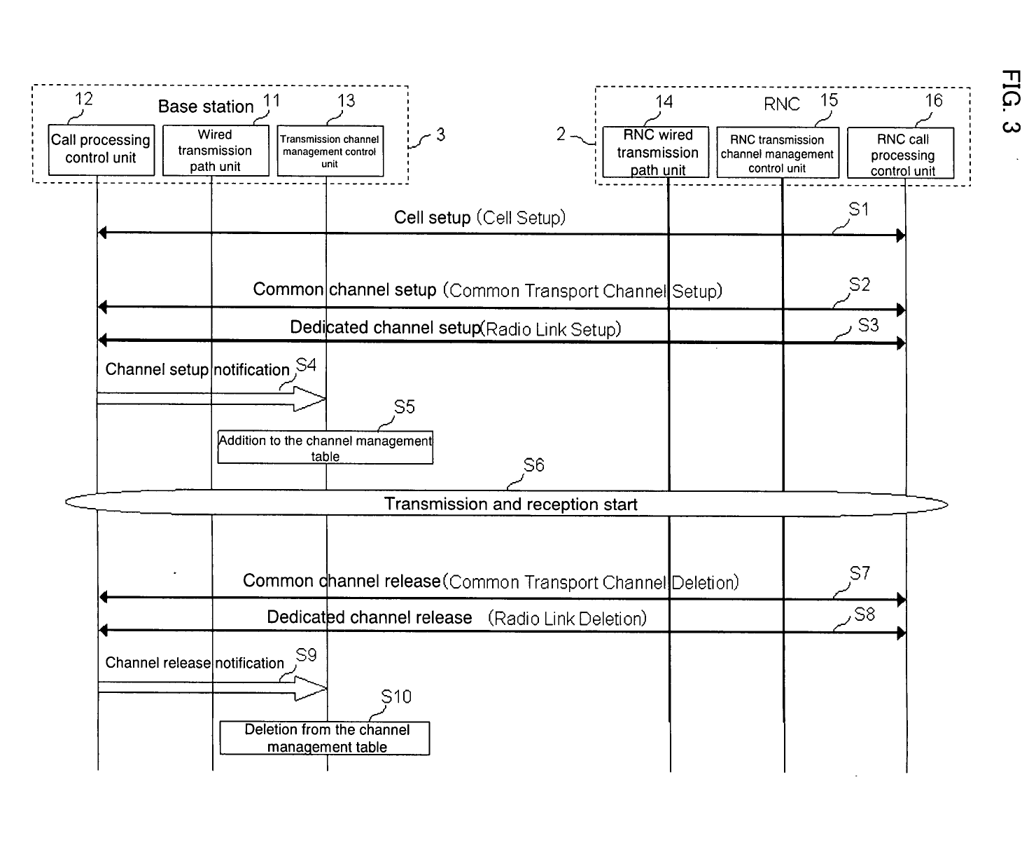

In the following, an operation of the embodiment of the invention will be described. FIG. 3 is an operation sequence diagram showing an internal process flow as to the transmission channel management control unit 13 from when a user call occurs (comes in or is made) to when the call is cleared (disconnected) on the Iub, the transmission path interface between the base station 3 and the RNC 2.

A transmission channel is classified as a physical channel or a transport channel, according to the interface. A physical channel is a channel between the user equipment (UE) 6 and the base station 3. A transport channel is a channel between the base station 3 and the RNC 2.

Moreover, a channel is classified as a common channel or a dedicated channel, according to the function or characteristics of the transmission signal. A common channel is a channel used in common among all pieces of user equipment (UE) 6. A dedicated channel is a channel used individually by each piece of user equipment (UE) 6. Examples of channels are a common channel FACH (Forward Access Channel), a dedicated channel DCH (Dedicated Channel), and the like.

In FIG. 3, the base station 3 sets with the RNC 2 a radio coverage of the base station 3 by means of the call processing control unit 12 via a cell setup (Cell Setup) message (step S1). The base station 3 then becomes capable of accepting an occurrence of a user call. When a user call occurs, the call processing control unit 12 and an RNC call processing control unit 16 severally perform a common channel setup (Common Transport Channel Setup) (step S2) and a dedicated channel setup (Radio Link Setup) (step S3) between the base station 3 and the RNC 2. The call processing control unit 12 then notifies the transmission channel management control unit 13 that a channel has been set up (step S4). On receiving the notification, the transmission channel management control unit 13 adds the set up transport channel to a channel management table 31 in the transmission channel management control unit 13 (step S5), and manages channels currently used as transfer paths. Though not shown in FIG. 3, the RNC 2 performs the same process as the base station 3. A channel setup is completed in this way, and then voice or packet communication is started (step S6).

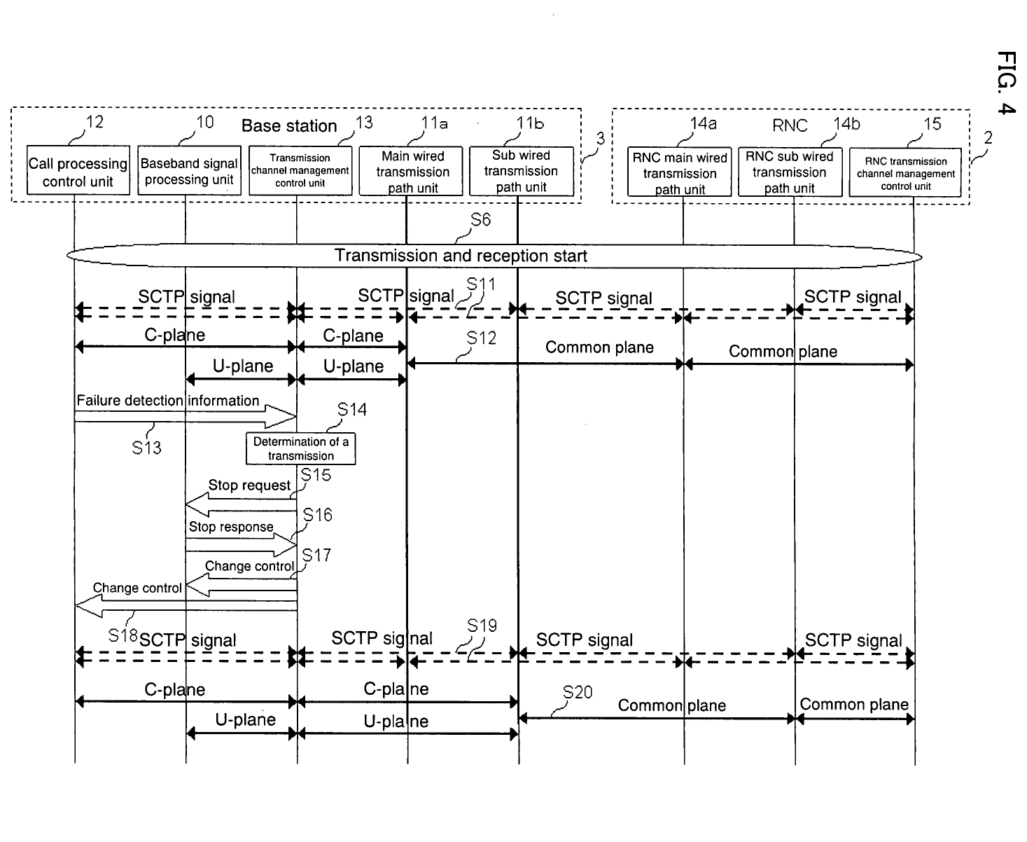

FIG. 5 shows details of the channel management table 31. Management information is divided into communication IP information 18, channel identification 19, a channel type 20, and a session ID 21, and is for managing these four items assigned to one channel for which a setup request is made. The communication IP information 18 is for managing an IP address and port number at each of the base station 3 and RNC 2. The channel identification 19 is for managing a channel class (common channel or dedicated channel). The channel type 20 is for managing a channel description (CCCH, DCCH, or the like). The session ID 21 is for managing a session for each of the user equipment (UE) 6 by identifying the session with an ID (numerical value).

On the other hand, when a user call is cleared in FIG. 3, the call processing control unit 12 and the RNC call processing control unit 16 perform a common channel release (Common Transport Channel Deletion) (step S7) and a dedicated channel release (Radio Link Deletion) (step S8) between the base station 3 and the RNC 2. The call processing control unit 12 then notifies the transmission channel management control unit 13 that a channel has been released (step S9). The transmission channel management control unit 13 then deletes the released transport channel from the channel management table 31 (step S10). Though not shown in FIG. 3, the RNC 2 performs the same process as the base station 3. A channel release is completed in this way, and voice or packet communication is disconnected. The embodiment is an example of a channel management from when a user call occurs to when the call is cleared. Alternatively, also in a case where a change of the channel type 20 occurs during a call, or where an addition of a dedicated channel (Radio Link Addition Request) or the like occurs, the same process as in step S4 and in step S5 is performed.

FIG. 4 is an operation sequence diagram showing a flow in which the transmission channel management control unit 13, upon a state of congestion caused by an increase in communication data and upon an unexpected failure of an IP transmission path, chooses an available transmission path from the plurality of wired transmission path units 11 and changes the transfer path for C-plane and U-plane at the same time. In order to distinguish the wired transmission path units to be used for the change here, a currently-used transmission path is referred to as a main wired transmission path unit 11a, and a transmission path to which the currently-used transmission path is to be changed is referred to as a sub wired transmission path unit 11b.

In a state where voice or packet communication has been started (step S6), the call processing control unit 12 performs transmission of C-plane and control of an SCTP failure detection packet, and transmission is performed via the transmission channel management control unit 13 (step S11). An SCTP signal is transmitted to the currently-used main wired transmission path unit 11a and also to the not-currently-used sub wired transmission path unit 11b. The baseband signal processing unit 10 performs transmission of U-plane (step S12).

Upon detecting failure of a transmission path by an SCTP failure detection packet, the call processing control unit 12 notifies the transmission channel management control unit 13 of failure detection information 32 (step S13).

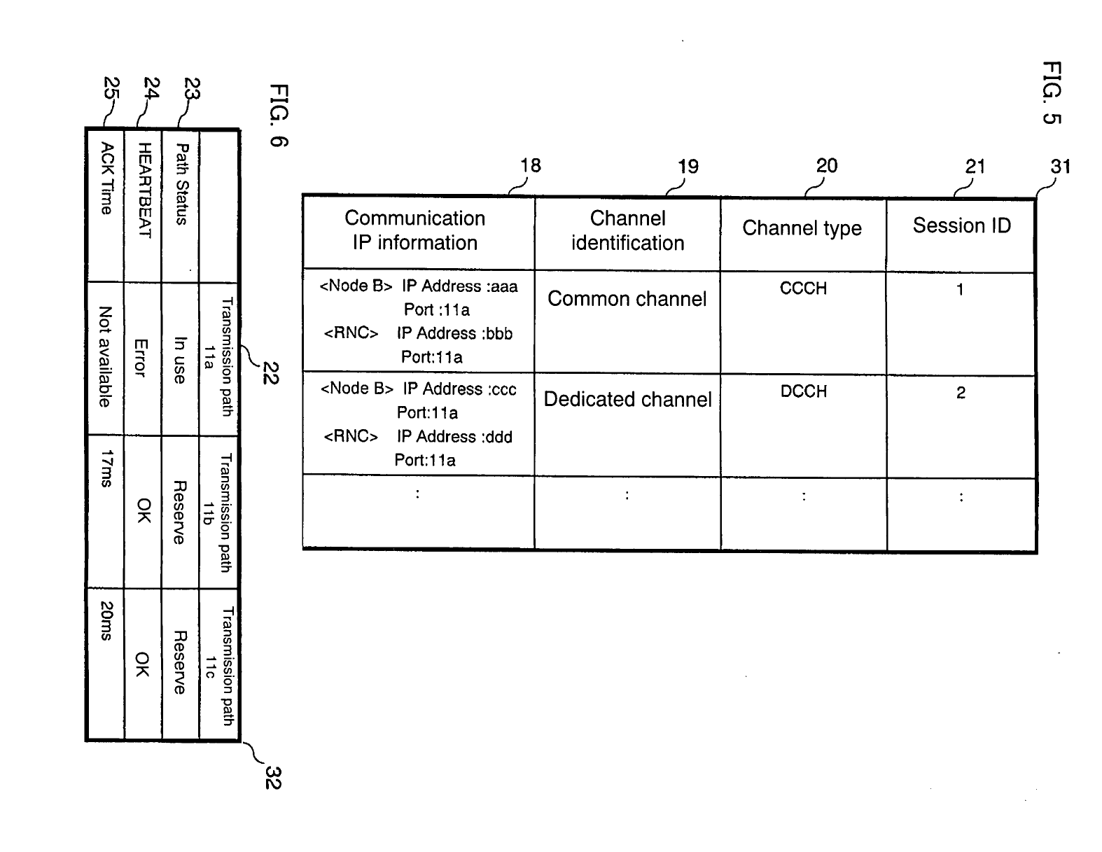

FIG. 6 shows details of the failure detection information 32. The failure detection information 32 takes the form in which the wired transmission path units 11 are described with their respective pieces of transmission path information 22. Path Status 23 shows a status of use of a transfer path. The status of use is divided into a path in use and a reserve path. HEARTBEAT 24 shows a result of status monitoring of a transmission path by an SCTP failure detection packet so as to distinguish whether the transmission path is available (OK) or not (Error). ACK Time 25 shows a result of measurement of a travel time (or round-trip time) of a failure detection packet. The failure detection information 32 in FIG. 6 indicates that a failure has occurred in the currently-used transmission path 11a, and that reserve transmission paths 11b and 11c are available without problems. The failure detection information 32 also indicates that the transmission path 11b is superior in quality as a transmission path to the transmission path 11c, because the travel time of the failure detection packet is shorter for the transmission path 11b than for the transmission path 11c.

Upon receiving a notification of the failure detection information 32, the transmission channel management control unit 13, based on the failure detection information 32, identifies a transmission path where a failure has occurred, and identifies a channel set up in the transmission path with reference to the channel management table 31. The transmission channel management control unit 13 changes the identified channel to a transmission path where no failure has occurred. In the embodiment, the transmission channel management control unit 13 determines, as the transmission path to which the identified channel is to be changed, a transmission path having the shortest travel time (ACK Time) of the failure detection packet among transmission paths where no failure has occurred (S14). In the example shown in FIG. 6, since the ACK Time of the transmission path 11b is shorter than that of the transmission path 11c, the transmission path 11b is determined as the transmission path to which the identified channel is to be changed.

In order to stop the use of the main wired transmission path unit 11a where a failure has occurred, the transmission channel management control unit 13 then notifies the baseband signal processing unit 10 of a stop request 33 for U-plane (step S15), and waits until a stop response is sent back (step S16).

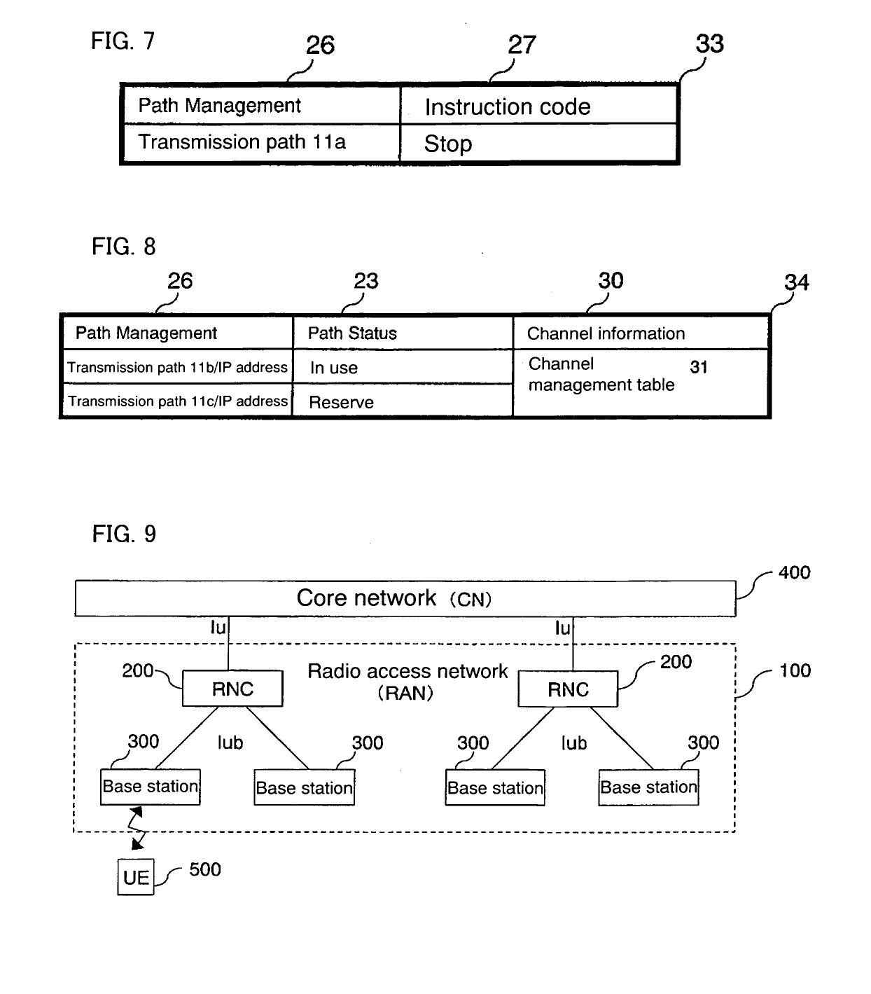

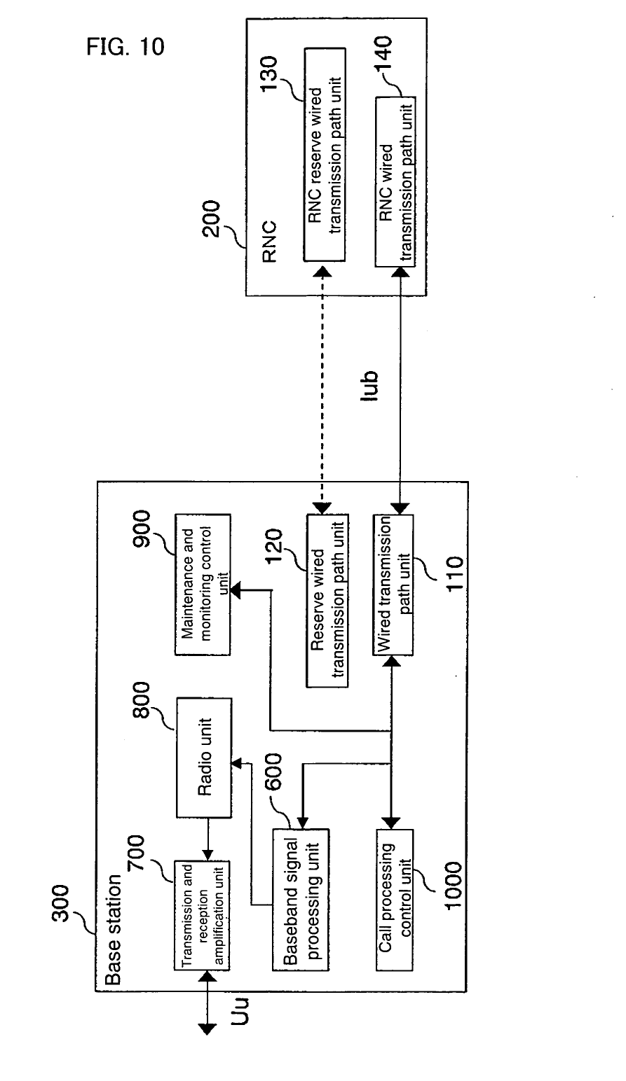

FIG. 7 shows details of the stop request 33 for U-plane. Path Management 26 is for identifying information on a transmission path to be managed. An instruction code 27 is an identifier for determining a process for a transmission path designated by the Path Management 26, indicating a stop instruction. The stop request 33 in FIG. 7 indicates that transmission of U-plane on the transmission path 11a is to be stopped.

After receiving a stop response from the baseband signal processing unit 10, the transmission channel management control unit 13 notifies the baseband signal processing unit 10 and the call processing control unit 12 of a change control request 34 (steps S17 and S18) in order to change the transmission on the Iub to the sub wired transmission path unit 11b where no failure has occurred.

FIG. 8 shows details of the change control request 34 for changing the transmission on the Iub. As in the case of FIG. 7, the Path Management 26 is for identifying information on a transmission path to be managed and an IP address thereof. Each transmission path has the Path Status 23 shown in FIG. 6, as information on a transmission path to be subjected to change control. Channel information 30 is the channel management table 31 where registration was made when a user call occurred, and is information on a channel whose transmission path is required to be changed. The transmission channel management control unit 13 here overwrites the communication IP information 18 in the channel management table 31 with an IP address corresponding to a wired transmission path unit to which the identified channel is to be changed; gives the IP address to the table; and includes the IP address in the information of the Path Management 26. This allows the baseband signal processing unit 10 and the call processing control unit 12 to determine the transmission path to which the identified transmission path is to be changed and the channel that is required to be changed. The change control request 34 shown in FIG. 8 indicates that the transmission path 11b is to be used and the transmission path 11c is to be a reserve, based on the channel information 30.

The baseband signal processing unit 10 and the call processing control unit 12 then, referring to the description of the change control request 34, controls to change the path to an available transmission path, and restarts transmission of C-plane and U-plane (steps S19 and S20). Though not shown in FIG. 4, the RNC 2 performs the same process as the base station 3. In this way, upon a state of congestion of a transmission path and upon an unexpected failure of a transmission path, the transmission path can be changed to an available transmission path among the plurality of wired transmission path units 11.

In the embodiment, when a state of congestion or failure occurs in a transmission path, the transmission channel management control unit can manage a used channel and a plurality of transmission path units and can perform a change process. Consequently, in a W-CDMA based mobile communications system, when a state of congestion of a transmission path occurs due to data-intensive communication data such as moving images or the like used by many users, or also when an unexpected failure occurs in a currently-used transmission path, the transmission path for transmission between the base station 3 and the RNC 2 in the RAN 1 can be controlled to be changed for C-plane and U-plane at the same time. The embodiment has the advantage of being able to reduce the possibility of an interruption of voice and disconnection of a call at the time of failure.

While there has been described what are at present considered to be preferred embodiments of the invention, it will be understood that various modifications may be made thereto. It is intended that claims cover all modifications as fall within the true spirit and scope of the invention.

### INDUSTRIAL APPLICABILITY

The invention can reduce the possibility of an interruption of voice and disconnection of a call at the time of failure by changing a channel set up in the transmission path where the failure has occurred to a transmission path where no failure has occurred. The invention has this great advantage, and is useful as a radio base station device or the like supporting an IP transmission system.

1. A radio base station device comprising:
a call processing control unit for transferring a signaling control signal, and transmitting a failure detection packet to a plurality of transmission paths connected to a radio network controller so as to detect failure of each of the transmission paths;
a baseband signal processing unit for transferring a user data control signal;
a channel management table storing a currently set up channel and a transmission path used by the channel, as being associated with each other; and
a channel management control unit for, in response to detection of failure of a transmission path by the call processing control unit, receiving information indicating a state of each of the transmission paths from the call processing control unit, identifying with reference to the channel management table a channel using the transmission path having failure detected, changing the identified channel to a transmission path having no failure detected, and notifying the call processing control unit and the baseband signal processing unit of an address related to the transmission path to which the identified channel is changed.

2. The radio base station device according to claim 1, wherein the channel management control unit updates the channel management table in response to a setup and release of a channel with a radio network controller.

3. The radio base station device according to claim 1, wherein the channel management control unit determines the transmission path to which the identified channel is to be changed, based on travel time information of the failure detection packet included in information indicating a state of each of the transmission paths.

4. The radio base station device according to claim 1, comprising a priority-of-use storage unit storing information indicating a predetermined priority of use for each of the transmission paths, wherein the channel management control unit determines the transmission path to which the identified channel is to be changed, based on the priority of use for each transmission path read from the priority-of-use storage unit.

5. A radio network controller comprising:
a call processing control unit for transferring a signaling control signal, and transmitting a failure detection packet to a plurality of transmission paths connected to a radio base station device so as to detect failure of each of the transmission paths;
a baseband signal processing unit for transferring a user data control signal;
a channel management table storing a currently set up channel and a transmission path used by the channel, as being associated with each other; and
a channel management control unit for, in response to detection of failure of a transmission path by the call processing control unit, receiving information indicating a state of each of the transmission paths from the call processing control unit, identifying with reference to the channel management table a channel using the transmission path having failure detected, changing the identified channel to a transmission path having no failure detected, and notifying the call processing control unit and the baseband signal processing unit of an address related to the transmission path to which the identified channel is changed.

6. A radio control system for performing communication between a portable terminal and a radio network controller via a radio base station device, the radio base station device and the radio network controller being connected to each other by a plurality of transmission paths, the radio base station device and the radio network controller comprising:
a call processing control unit for transferring a signaling control signal, and transmitting a failure detection packet to each of the transmission paths so as to detect failure of each of the transmission paths;
a baseband signal processing unit for transferring a user data control signal;
a channel management table storing a currently set up channel and a transmission path used by the channel, as being associated with each other; and
a channel management control unit for, in response to detection of failure of a transmission path by the call processing control unit, receiving information indicating a state of each of the transmission paths from the call processing control unit, identifying with reference to the channel management table a channel using the transmission path having failure detected, changing the identified channel to a transmission path having no failure detected, and notifying the call processing control unit and the baseband signal processing unit of an address related to the transmission path to which the identified channel is changed.

7. An operation control method of a radio base station device, the radio base station device comprising: a call processing control unit for transferring a signaling control signal; a baseband signal processing unit for transferring a user data control signal; and a channel management control unit for managing a channel set up with the radio network controller, the operation control method comprising:
a table update step in which the channel management control unit, in response to a setup and release of the channel, updates a channel management table storing a currently set up channel and a transmission path used by the channel, as being associated with each other;
a failure detection step in which the call processing control unit transmits a failure detection packet to a plurality of transmission paths connected to a radio network controller so as to detect failure of each of the transmission paths;
a state-of-transmission-path transmission step in which the call processing control unit, in response to detection of failure of a transmission path in the failure detection step, transmits information indicating a state of each of the transmission paths to the channel management control unit; and
a transmission path change step in which the channel management control unit identifies with reference to the channel management table a channel using the transmission path having failure detected, changes the identified channel to a transmission path having no failure detected, and notifies the call processing control unit and the baseband signal processing unit of an address related to the transmission path to which the identified channel is changed.

8. The operation control method according to claim 7, wherein the channel management control unit, in the transmission path change step, determines the transmission path to which the identified channel is to be changed, based on travel time information of the failure detection packet included in information indicating a state of each of the transmission paths.

9. The operation control method according to claim 7, wherein the transmission path change step comprises:
a step in which the channel management control unit reads, from a priority-of-use storage unit storing information indicating a predetermined priority of use for each of the transmission paths, the information indicating the priority of use; and
a step of determining the transmission path to which the identified channel is to be changed, based on the priority of use for each transmission path read from the priority-of-use storage unit.
